(19) United States
(12) Patent Application Publication
(10) Pub. No.: US 2009/0290658 A1
(43) Pub. Date: Nov. 26, 2009

(54) Multi-Pulse Signal Generator Based on a Sawtooth Chirp

(76) Inventors: George Moore, Veradale, WA (US); Nicholas Tufillaro, Corvalis, OR (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/125,698

(22) Filed: May 22, 2008

(51) Int. Cl. H04L 27/00

(52) U.S. Cl. 375/295

(57) ABSTRACT

A method generating a digital waveform, pulse generators and VNAs based thereon are disclosed. The digital waveform is generated in response to user-supplied parameters defining a sawtooth chirp signal. A digital baseband chirp signal that depends on the input parameters is first generated and then the digital baseband signal is upconverted to a center frequency to form an upconverted chirp signal. The upconverted chirp signal is then converted to an M-ary signal having M levels and then (optionally) filtered through a band pass filter to attenuate frequency components of the digital chirp signal outside a predetermined band of frequencies. The digital baseband chirp signal can also include the sum of first and second chirp signals having amplitudes and phase determined to reduce variations in amplitude as a function of frequency in a predetermined band of frequencies.

### BACKGROUND OF THE INVENTION

Determining the frequency response of a device is a common problem. In the simplest case, the device under test (DUT) is stimulated with a single tone signal, and the response of the DUT as a function of frequency is measured. If the DUT is linear, the outputs of the DUT at the tone frequency are sufficient to characterize the DUT and are often measured in a vector network analyzer (VNA). To fully characterize the DUT as a function of frequency, this procedure is repeated at a number of different stimulation frequencies. However, if the number of test frequencies is large, this procedure can require a significant length of time to complete. Even if the time interval required to completely test the circuit is acceptable, the circuit parameters can change over the course of the test due to changes in environmental variables such as temperature. Hence, methods that reduce the test time have been sought.

One solution to this problem involves using a more complex stimulation signal having a number of different tones and measuring the response of the DUT at each of the tones simultaneously. Test systems based on these more complex signals require substantially less time to fully characterize the DUT; however, problems arise if the output signal from the DUT has a small amplitude at one or more of the test frequencies. For example, a DUT consisting of a bandpass filter will have very low amplitude output signals at frequencies out of the pass band of the filter; however, the shape of the pass band is an important characteristic that needs to be measured.

These problems are often the result of the noise floor in the receiver in the VNA used to measure the output of the DUT. There is a limit to the power that can be input to the DUT, and hence, the power in the signal received from the DUT is limited. The receiver has some minimum noise that interferes with the measurement of the signals from the DUT. Hence, the test system can be used over some dynamic range that is determined by the noise floor of the receiver. For the purposes of this discussion, the dynamic range of the receiver is the ratio of the maximum signal that can be measured to the minimum signal that can be measured, which is a function of the signal-to-noise ratio in the receiver.

If a single tone test signal is utilized, all of the power is concentrated in this test signal, and hence, the output of the DUT at that frequency is also at the maximum value that can be obtained consistent with the limitations on the input signal power. Accordingly, this type of test system will have the greatest dynamic range. When the power is spread among a number of frequencies, the output of the DUT at each frequency is reduced, and hence, the signal-to-noise ratio in the receiver at each of the frequencies is likewise reduced. In addition, the noise levels associated with these multi-tone systems are greater than those encountered in a single tone system. As a result of these factors, the dynamic range of the multi-tone test systems is typically less than that of the single tone systems. Hence, there is a tradeoff between the number of frequencies that can be tested with a single stimulus signal and the dynamic range of the resulting test measurements.

In addition to the dynamic range limitations, the generation of these more complex signals becomes problematic. In principle, a stimulation signal having the desired frequency spectrum can be generated by combining a number of single tones numerically on a computer to provide a digital representation of the desired stimulus signal. The digital signal values are then stored in the memory of a pattern generating circuit that feeds the signal values to a digital-to-analog converter whose output provides the analog stimulus signal. Unfortunately, at very high frequencies, the cost of the digital-to-analog (DAC′) converter becomes limiting, in fact, high dynamic range DAC's, e.g. 15 bit, are not currently available at high frequencies.

To overcome the digital-to-analog converter limitation, stimulus signals that consist of binary sequences, referred to as multi-pulse signals, have been utilized. In this case, the stimulus signal has two discrete values. The transitions between these values occur at times specified by a clock. Hence, the signals can be generated by reading out the memory into a simple driver circuit whose output is used to stimulate the DUT. Thus, replacing multi-tone test signals with suitable binary test sequences, where possible, is very advantageous for reducing cost and increasing the speed for testing devices at high frequencies.

The conversion of a multi-tone test signal to a suitable binary test sequence poses some significant problems. The energy spectrum of the multi-pulse signal is only approximately that of the multi-tone signal. Much of the energy of the multi-pulse signal will be outside the frequency range of interest, and hence, wasted. In addition, the relative intensities of the frequency components at the desired frequencies can be altered by the conversion process. Both of these factors limit the dynamic range of the test system in which the multi-pulse signal is utilized.

One method for generating a binary test sequence uses a search procedure in which the relative amplitudes and phases of the individual tones of the original multi-tone test signal that are combined to produce the stimulus signal are adjusted such that the signal energy is constrained to reside within the desired frequency band. This approach requires an optimization process that is computationally intensive, and hence is not well suited to a real-time implementation on the processors that are typically utilized as controllers in the pulse generators, or test systems. If only one such signal is needed, the optimization can be performed on a computer having the required computational power that is different from the computer in the test system and stored for later use. However, in many applications, the user of the test system wishes to specify the frequency range of the stimulus signal and the rate at which the signal energy falls off as a function of frequency outside of that range. In this case, the test system processor must perform the optimization, and hence, this optimization approach is not practical.

### SUMMARY OF THE INVENTION

The present invention includes a method for generating a digital waveform, and pulse generators and VNAs based thereon. The digital waveform is generated in response to user-supplied parameters defining a sawtooth chirp signal. An upconverted digital chirp signal at a center frequency that depends on the input parameters is first generated. The upconverted chirp signal is then converted to an M-ary signal having M levels, where M>1 and typically M<9. In one embodiment, M=2. In another embodiment, the upconverted digital chirp signal is generated by generating a baseband chirp signal that conforms to the user-supplied parameters and then upconverting the baseband chirp signal to the desired center frequency. In another embodiment, the digital baseband chirp signal is filtered through a band pass filter to attenuate frequency components of the digital baseband chirp signal outside a predetermined band of frequencies. In yet another embodiment, the digital baseband chirp signal includes the sum of first and second chirp signals having amplitudes and phase determined to reduce variations in amplitude as a function of frequency in a predetermined band of frequencies.

The digital waveform can be stored in a signal generator that has a memory for storing the M-ary digital signal, a controller, and a user interface. The controller causes the M-ary digital signal to be readout at a specified rate into a driver circuit that generates an output signal corresponding to the M-ary signal, the output signal having M signal levels. The controller receives input parameters on the user interface that specify the M-ary signal and the specified rate. In one embodiment, the controller generates the M-ary signal from user-defined parameters received on the user interface.

A pulse generator according to the present invention can be incorporated into a VNA. In one embodiment, the VNA includes a mixer LO signal generator that generates a M-ary mixing signal according to the present invention. In another embodiment the VNA includes a test signal generator that provides a corresponding M-ary signal for application to a DUT, the outputs of the DUT being measured with a mixer that utilizes the mixer LO signal.

### BRIEF DESCRIPTION OF THE DRAWINGS

FIG. 1 is a flow chart of one embodiment of a signal generation algorithm according to the present invention.

FIG. 2 illustrates a multi-pulse signal generator according to one embodiment of the present invention.

FIG. 3 illustrates one embodiment of a receiver with a multi-pulse local oscillator.

FIG. 4 illustrates a dual mode VNA according to one embodiment of the present invention.

FIG. 5 illustrates another embodiment of a signal generator according to the present invention.

### DETAILED DESCRIPTION OF THE PREFERRED EMBODIMENTS OF THE INVENTION

The present invention generates a stimulus signal that has its power concentrated in a user defined frequency band. The stimulus signal of the present invention is analogous to a sawtooth chirp signal. A sawtooth chirp signal has a frequency spectrum in which the energy is concentrated in a predetermined band of frequencies and then falls off rapidly at frequencies to either side of the band. Within the band, the amplitude as a function of frequency is relatively constant. The present invention utilizes this property of the sawtooth chirp signal to construct a multi-pulse signal that has similar frequency properties. The constant envelope nature of the chirp signal allows a binary or low level of quantization representation to better approximate its spectrum.

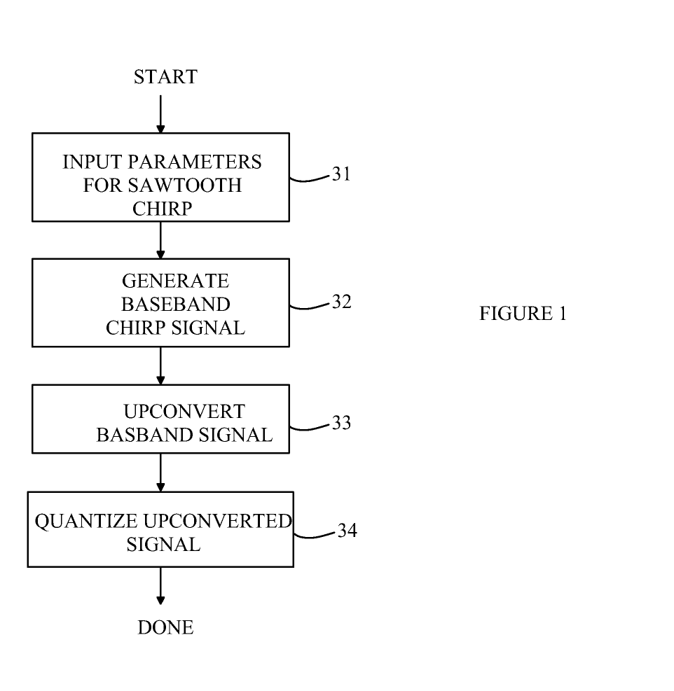

The manner in which the present invention generates a multi-pulse signal having the desired properties can be more easily understood with respect to FIG. 1, which is a flow chart of one embodiment of a signal generation algorithm according to the present invention. First the user inputs the parameters that specify the desired stimulus signal in terms of a time-bandwidth product G and the number of points in the discrete signal, N, as shown at 31. Here, G=α*N² and G is roughly the number of comb lines in the frequency spectrum of the baseband signal. The constant α is computed from the values of G and N.

Next, a discrete sawtooth chirp signal, z(n), at baseband is generated, as shown at 32, according to the relationship:

z(n)=exp(j2π(αn²/2)+γ)

for n=−N/2 to N/2−1. Here, γ sets an overall phase factor and can typically be chosen to be 0. The cases in which this phase factor is non-zero will be discussed below.

The baseband chirp signal is then upconverted to a user defined normalized carrier frequency, f_{nc}, as shown at 33. The upconversion can be carried out digitally on the data processing system. It should be noted that z(n) is a complex signal. The upconverted signal must be real, as this is the signal that determines the stimulus signal. The real-valued upconverted signal, x_{IF}(n) is given by

x_{IF}(n)=Real(z(n))*Real(exp(j2πnf_{nc}))−Imag(z(n))*Imag(exp(j2πnf_{nc}))

Next, the upconverted signal is converted to a binary signal by quantizing the signal to two values as shown at 34. For example, assume that the amplitude of x_{IF}(n) is between −1 and +1. Then the binary signal, B_{IF}(n), is set to 1 if x_{IF}(n) is ≧0, and B_{IF}(n) is set to 0 if x_{IF}(n)<0.

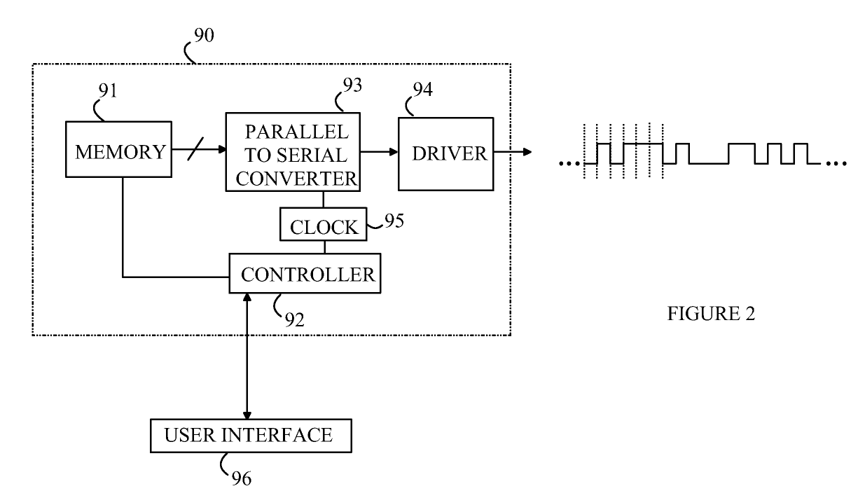

The binary signal can then be utilized in a pattern generator to provide a stimulus signal whose energy is concentrated in the desired frequency band by adjusting the sequence of values at which the individual values are transmitted from the pattern generator. Refer now to FIG. 2, which illustrates a multi-pulse signal generator according to one embodiment of the present invention. Multi-pulse signal generator 90 generates a signal that is specified by a sequence of bits that are stored in a memory 91. To improve the speed of the multi-pulse signal generator, the sequence can be divided into multi-bit words within memory 91. Each word is transferred in parallel to a parallel-to-serial converter 93. Such a converter can be constructed, for example, from a shift register. At each clock pulse from clock 95, parallel-to-serial converter 93 outputs the next bit of the word. The output of parallel-to-serial converter 93 forms the input to a driver 94 that converts the binary value to a voltage, a binary 0 being converted to V₁ and a binary 1 being converted to V₂. The center frequency of the frequency spectrum of the output signal is determined by the rate at which controller 92 outputs bits from parallel-to-serial converter 93.

In one embodiment, controller 92 also generates the patterns stored in memory 91 using an algorithm that includes the steps discussed above. The user inputs the parameters that specify the signal via user interface 96. User interface 96 can also include a display device so that controller 92 can provide a graphical representation of the frequency spectrum of the multi-pulse signal generated in response to the user's input. If the user is not satisfied with the frequency spectrum, controller 92 can then modify the signal using one of the approaches discussed below.

It should be noted that in embodiments in which controller 92 generates the patterns, controller 92 may include special purpose hardware. For example, the baseband chirp could be generated by cascading digital integrators to provide the input to a sine/cosine generator. Since such hardware is known to the art, it will not be discussed in detail here. An example of such a chirp generating system can be found in U.S. Pat. No. 6,178,207.

In the embodiment shown in FIG. 2, multi-pulse signal generator 90 utilizes a parallel-to-serial converter to output the multi-pulse signal stored in memory 91 one bit at a time. However, other circuit arrangements could be utilized. For example, parallel-to-serial converter 93 could be replaced by a multiplexer that sequentially selects bits from a register in memory 91. If the output speeds are sufficiently low, memory 91 can be organized as a one bit wide memory and the output of the memory coupled directly to driver circuit 94.

A multi-pulse generator according to the present invention can be used to provide an excitation signal for testing the response of a DUT or a periodic signal for use in characterizing a DUT at a number of harmonically related frequencies. A periodic signal is generated by repeating the stored signal with a period that sets the fundamental of the harmonics in the signal. The harmonics have amplitudes determined by the upconverted chirp signal.

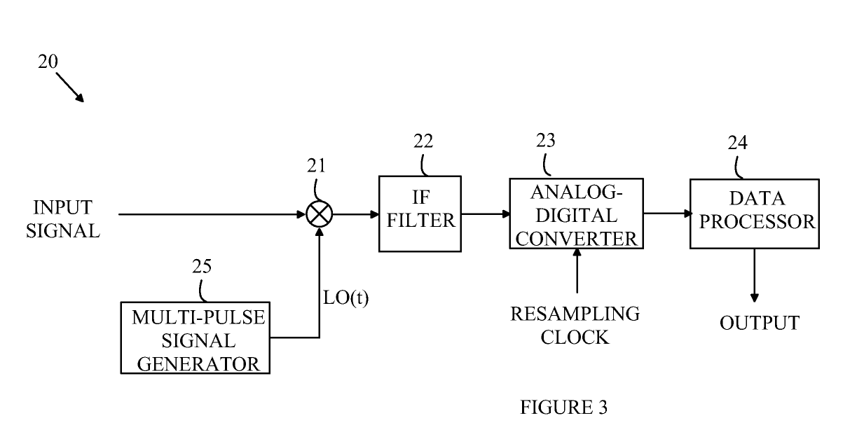

A multi-pulse generator according to the present invention can be utilized to provide a multi-pulse local oscillator signal to a mixer in a receiver of a vector network analyzer as well as a stimulus signal that is applied to a DUT whose output is analyzed by the receiver. Refer now to FIG. 3, which illustrates one embodiment of a receiver with a multi-pulse local oscillator [LO]. The input signal to receiver 20 is mixed with a repetitive LO signal generated by a multi-pulse signal generator according to the present invention by repetitively generating the sequence of pulses discussed above with a period that determines the locations of the comb lines in the LO signal. The output of mixer 21 is low pass filtered through filter 22 and digitized by analog-to-digital converter 23. The output of analog-to-digital converter 23 is processed by data processor 24 to provide measurements of the amplitude and phase of the input signal's frequency components.

The mixer shown in FIG. 3 can be utilized to measure the amplitude and frequency of the input signal at a number of different frequencies simultaneously. It is assumed that the input signal is periodic, and hence, represented by a harmonic series. The LO signal has a number of different harmonics as well. The harmonics in the LO signal are chosen such that each harmonic down-converts one or more of the input harmonics to frequencies within the pass band of filter 22. In addition, the harmonics of the LO signal are chosen such that the down-converted harmonics in the input signal generated by one harmonic in the LO signal are at distinct frequencies from those down-converted by another harmonic in the LO signal. Hence, by properly choosing the harmonics in the LO signal relative to those of interest in the input signal, the output of filter 22 will have one frequency component for each harmonic of interest in the input signal. The amplitude and phase of each of the harmonics of interest in the input signal can then be recovered by digitizing the output of filter 22 and performing a Fourier analysis of that output.

Each of the harmonics in the LO signal also down-converts noise from the input signal. While the down-converted harmonics in the input signal do not overlie one another, the noise spectrums that are down-converted do overlap one another. Hence, the noise in the output of filter 22 is significantly higher than the noise in the original input signal. As noted above, this increased noise limits the number of harmonics in the input signal that can be measured at once.

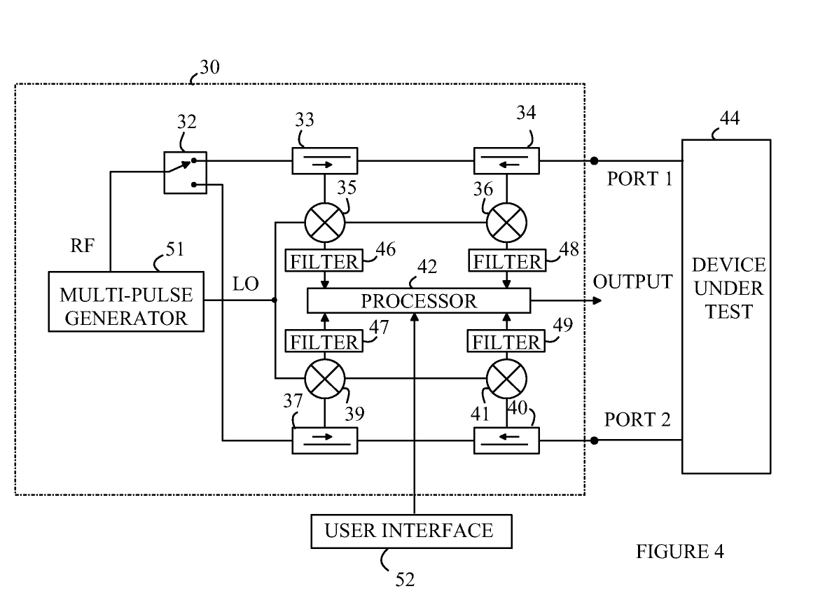

A multi-pulse signal generator 25 according to the present invention can be used both to generate the stimulus signal and the LO signal in a VNA. Refer now to FIG. 4, which illustrates a dual mode VNA according to one embodiment of the present invention. VNA 30 is a two port VNA that is adapted for making measurements of two ports on a DUT 44. In each measurement, an RF signal generated by multi-pulse signal generator 51 is applied to one of the ports on DUT 44 and the signals leaving that port and a second port are analyzed by VNA 30. The port that is to receive the RF signal is determined by switch 32. In the example shown in FIG. 4, the RF signal is applied to port 1 of DUT 44. However, embodiments in which each port is connected to a separate test input signal port and the selection of which port receives the RF signal is made manually could also be constructed.

The RF signal that is applied to DUT 44 is measured prior to applying the signal to DUT 44 by coupling a fixed fraction of the RF signal energy to a mixer that receives an LO signal from multi-pulse signal generator 51. In the example shown in FIG. 4, the RF signal is measured by coupling the RF signal to mixer 35 via a unidirectional coupler 33. When the RF signal is applied to port 2, the RF signal is measured by coupling the RF signal to mixer 39 via unidirectional coupler 37. The output of mixers 35 and 39 are filtered by bandpass filters 46 and 47, respectively, to eliminate the higher mixing products. The outputs of filters 46 and 47 are then processed by processor 42, which includes an analog-to-digital converter that digitizes the output of the filters that is then analyzed to determine the amplitude and phase of the RF signal components of interest that are being applied to DUT 44.

The signals that leave the two ports of DUT 44 are coupled to mixers 36 and 41 by unidirectional couplers 34 and 40, respectively. These signals are mixed with the LO signal from multi-pulse signal generator 51 and filtered through IF filters 48 and 49, respectively. The outputs of filters 48 and 49 are then analyzed by processor 42 to determine the amplitude and phase of each of the harmonics of interest in the signal from DUT 44.

The parameters that determine the RF signal and LO signals are input through user interface 52 to processor 42. Processor 42 then loads the relevant memories in multi-pulse signal generator 51 with the waveforms for the RF and LO signals. These binary waveforms are then sent one bit at a time on the relevant signal lines at clock rates determined by the information input by the user. In one embodiment, the waveforms are generated on demand by processor 42 using an algorithm similar to the one described above. In another embodiment, a number of pre-calculated waveforms are stored in the memory of processor 42 and the relevant waveforms are transferred to the memories of the pattern generators contained in multi-pulse signal generator 51.

The above-described embodiments of a multi-pulse signal generator assume that the original discrete sawtooth chirp signal, z(n), is satisfactory in terms of the uniformity of amplitude as a function of frequency in the desired band and the fall off in amplitude outside that band. In one embodiment of the present invention, the DFT of z(n) is computed and the power spectrum is examined to determine if the in-band amplitude variations are sufficiently small and the out-of-band falloff in intensity is sufficiently large to meet a criterion set by the user. The examination can be performed by the user via the user interface or by controller 92 shown in FIG. 2.

The above-described embodiments of VNAs according to the present invention have 2 ports. However, embodiments that utilize the present invention and have higher numbers of ports could also be constructed.

If the single sawtooth chirp signal is unsatisfactory, a multiple chirp signal can be examined. That is, z(n) is replaced by a multi-chip signal such as

$$z ( n ) = {\sum }_{i} {A}_{i} exp ( j 2 π ( α {n}^{2} / 2 ) + {γ}_{i} )$$

Here, the amplitudes, Aᵢ, and the relative phases, γ_{I}, are adjusted to provide a more uniform amplitude as a function of frequency for the in-band signal frequencies. In one embodiment, these parameters are varied until the RMS amplitude variation within the band of interest is either minimized or less than some predetermined level. If the out-of-band fall off is insufficient, the fall off can be reduced by filtering z(n) through a bandpass filter that attenuates frequency components that are output by the desired band. Once a satisfactory z(n) is obtained. The z(n) is upconverted as described above.

The quantization of the x_{IF} to generate B_{IF} also alters the frequency spectrum of x_{IF}. The hard limiting of the upconverted signal to generate the binary signal moves some of the signal energy into bands outside the band of interest. If the signal is limited such that the signal has more levels, the amount of energy that is moved out of the band by the limiting process is reduced. Hence, B_{IF}(n) will have a power spectrum as a function of frequency that is not as constant as that of x_{IF}(n), and there will be more energy outside the band of interest. The above-described optimization process can also be used to correct for some of these distortions. In this case, the amplitudes, Aᵢ, and the relative phases, γ_{I}, are adjusted such that the power spectrum of the final binary signal has its energy concentrated in the in-band frequencies, and the deviations of the amplitude of the frequency components of the binary signal in the in-band region is minimized.

The above-described embodiments of the present invention generate a multi-pulse signal that has only two signal levels. As noted above, such signals are useful in applications in which the stimulus signal must be of a frequency that exceeds the capabilities of affordable digital-to-analog converters. In this regard, it should be noted that digital-to-analog converters having a few bits of resolution can operate at much higher frequencies than digital-to-analog converters having more bits of resolution, and are also significantly less expensive. Hence, if the application will allow the use of such a reduced resolution digital-to-analog converter, the upconverted signal can be converted to a signal having more than two levels by a suitable algorithm.

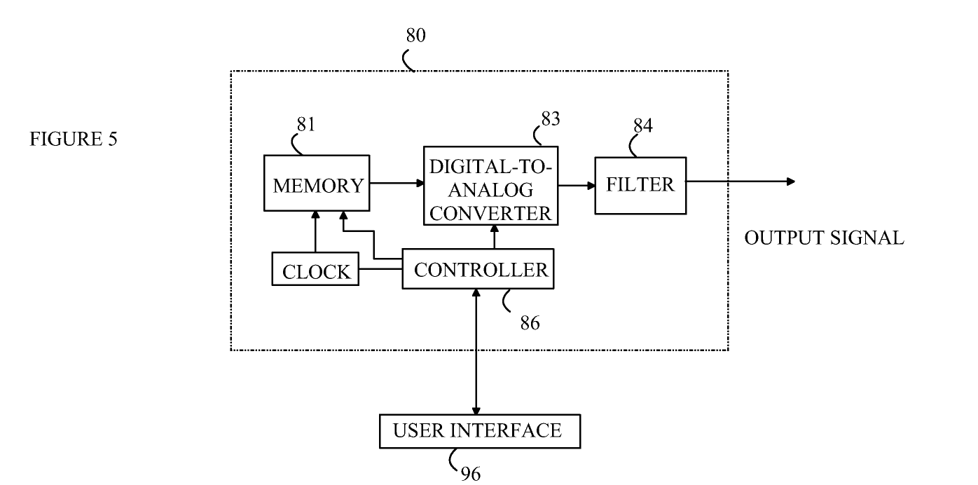

Refer now to FIG. 5, which illustrates another embodiment of a signal generator according to the present invention. Signal generator 80 includes a memory for storing a digital representation of an upconverted chirp signal that is generated by controller 86 in response to inputs from a user through interface 96. However, instead of being a binary signal, the digital signal stored in memory 81 is an M-ary signal. That is, the signal has M discrete signal values where M>2. In one embodiment of the present invention, M is also <9 since, at present, digital-to-analog converters having more than 8 bits are substantially more expensive and are much more limited in terms of the maximum operating speed that can be supported. The stored values are converted to an analog signal having M different voltage levels by digital-to-analog converter 83. The output of digital-to-analog converter 83 can be optionally filtered by a low pass filter 84 to remove some of the out of band energy created by the sharp transitions in the signals leaving digital-to-analog converter 83.

Various modifications to the present invention will become apparent to those skilled in the art from the foregoing description and accompanying drawings. Accordingly, the present invention is to be limited solely by the scope of the following claims.

What is claimed is:

1. A method generating a digital waveform on a data processing system, said method comprising:
receiving input parameters defining a sawtooth chirp signal;
generating a digital upconverted chirp signal conforming to said received input parameters; and
converting said upconverted chirp signal to an M-ary signal having M levels where M>1 and M<9.

2. The method of claim 1 wherein said upconverted chirp signal is generated by generating a digital baseband chirp signal that depends on said input parameters and upconverting said digital baseband signal to a center frequency to form an upconverted chirp signal.

3. The method of claim 1 wherein M=2.

4. The method of claim 1 further comprising filtering said digital baseband chirp signal through a band pass filter to attenuate frequency components of said digital baseband chirp signal outside a predetermined band of frequencies.

5. The method of claim 1 wherein said digital baseband chirp signal comprises the sum of first and second chirp signals having amplitudes and phase determined to reduce variations in amplitude as a function of frequency in a predetermined band of frequencies.

6. A signal generator comprising:
a memory for storing an M-ary digital signal having M levels where M>1 and M<9; and
a controller that causes said M-ary digital signal to be readout at a specified rate into a driver circuit that generates an output signal corresponding to said M-ary signal, said output signal having M signal levels;
a user interface that receives input parameters specifying said M-ary signal and said specified rate, wherein said M-ary signal comprises an upconverted digital baseband chirp signal that includes a digital baseband chirp signal that has been upconverted to a center frequency, said digital baseband chirp signal being determined by said input parameters.

7. The signal generator of claim 6 wherein said controller generates said M-ary signal in response to said input parameters being received on said user interface.

8. The signal generator of claim 6 wherein M=2.

9. The signal generator of claim 6 wherein said digital baseband chirp signal is filtered through a band pass filter to attenuate frequency components of said digital baseband chirp signal outside a predetermined band of frequencies prior to upconverting said digital baseband chirp signal.

10. The signal generator of claim 6 wherein said digital baseband chirp signal is filtered through a band pass filter to attenuate frequency components of said digital baseband chirp signal outside a predetermined band of frequencies after upconverting said digital baseband chirp signal.

11. The signal generator of claim 6 wherein said digital baseband chirp signal comprises the sum of first and second chirp signals having amplitudes and phase determined to reduce variations in amplitude as a function of frequency in a predetermined band of frequencies.

12. An apparatus comprising:
a first signal input port that receives a test signal;
an LO signal generator that generates a mixer LO signal, said mixer LO signal comprising a first M-ary signal that comprises an upconverted digital baseband chirp signal that includes a digital baseband chirp signal that has been upconverted to a center frequency;
a mixer driven by said mixer LO signal; and
an IF filter that filters an output of said mixer to generate an IF signal; and
a processor that analyzes said IF signal to determine a parameter characterizing said test signal and outputs that parameter.

13. The apparatus of claim 12 wherein M=2 and wherein said mixer LO signal comprises a periodic signal determined by said test signal.

14. An apparatus comprising:
a first signal input port that receives a first input test signal to be applied to a device under test (DUT);
an LO signal generator that generates a mixer LO signal comprising a first M-ary signal having M signal levels, wherein M>1 and M<9, comprising an upconverted digital baseband chirp signal that includes a digital baseband chirp signal that has been upconverted to a center frequency;
a first measurement channel comprising first and second mixer channels and a first measurement channel input port, each mixer channel comprising;
a coupler that applies a portion of a signal to a mixer corresponding to that channel, said mixer being driven by said mixer LO signal; and
a IF pass filter that filters an output of said mixer to generate an IF signal corresponding to that mixer channel,
said coupler in said first mixer channel of said first measurement channel being connected to said first measurement channel input port and a first device port, and said coupler in said second mixer channel of said first measurement port applying a portion of a signal received on said first device port to said mixer in said second mixer channel; and
a processor that analyzes said IF signals from said first and second mixer channels to determine a parameter characterizing said DUT and outputs that parameter.

15. The apparatus of claim 14 wherein M=2.

16. The apparatus of claim 14 wherein said first input test signal comprises a second M-ary signal having M signal levels, wherein M>1 and M<9, said second M-ary signal comprising an upconverted digital baseband chirp signal that includes a digital baseband chirp signal that has been upconverted to a center frequency, said first M-ary signal being related to said second M-ary signal and wherein said apparatus further comprises a signal generator that generates said first and second M-ary signals.

17. The apparatus of claim 16 wherein M=2.

18. The apparatus of claim 14 further comprising:
a second measurement channel comprising third and fourth mixer channels and a second measurement channel input port, each mixer channel comprising;
a coupler that applies a portion of a signal to a mixer corresponding to that channel, said mixer being driven by said mixer LO signal; and
an IF filter that filters an output of said mixer to generate an IF signal corresponding to that mixer channel,
said coupler in said third mixer channel of said second measurement channel being connected to said second measurement channel input port and a second device port, and said coupler in said fourth mixer channel of said second measurement port applying a portion of a signal received on said second device port to said mixer in said fourth mixer channel; and
a mechanism that selectively applies said first input test signal to either said first measurement channel input port or said second measurement channel input port to said first signal input port, wherein said processor also receives said IF signals from said third and fourth mixer channels.
